(19) United States
(12) Patent Application Publication
(10) Pub. No.: US 2020/0410497 A1
(43) Pub. Date: Dec. 31, 2020

(54) SYSTEMS AND METHODS TO DETECT FRADULENT TRANSACTIONS

(71) Applicant: ConnectWise LLC, Tampa, FL (US)

(72) Inventors: Jacob Edward Turpin, Raleigh, NC (US); Luthfi Bustillos-Francis, Durham, NC (US); Paul Jeffrey Bishop, Raleigh, NC (US)

(73) Assignee: ConnectWise LLC, Tampa, FL (US)

(21) Appl. No.: 16/456,577

(22) Filed: Jun. 28, 2019

(51) Int. Cl. G06Q 20/40

(52) U.S. Cl. CPC G06Q 20/4016; G06Q 20/4014

(57) ABSTRACT

Systems and methods of the present disclosure are directed to detect fraudulent transactions. The method include detecting an online transaction initiated by a computing device. The method includes determining, identifying that the online transaction is in a state, a value corresponding to information of the computing device or a field of the online transaction. The method includes obtaining a look-up value corresponding to the value. The method includes selecting a routing policy based on comparing the value with the look-up value. The method includes determining to interrupt the online transaction based on detecting a presence of a match between at least one of the value and the look-up value. The method can include interrupting, responsive to the determination, the online transaction to direct the online transaction to a resolving state according to the routing policy.

### FIELD OF THE DISCLOSURE

The present disclosure generally relates to managing online transactions. In particular, systems and methods of the present disclosure can detect computing devices that perform or are engaged in fraudulent online transactions.

### BACKGROUND OF THE DISCLOSURE

As the world becomes increasingly mobile, wireless and connected, analysts project increased growth in both the volume and the value of online transactions over the Internet. There is, however, great risk associated with merchants doing business on the Internet. The anonymity of online customers makes the incidence of fraud incomparably higher for online merchants than for brick-and-mortar, in-house shopping venues, where the customer is present for all transactions. Fraudulent network activity can result in wasted computing and network resources, or burden information technology infrastructure, which can introduce delays or latency in computing or network transactions.

### SUMMARY OF THE DISCLOSURE

At least one aspect of this disclosure is directed to a method for detecting fraudulent transactions. The method can include detecting, by a control system comprising a processor and memory, an online transaction initiated by a computing device. The method can include determining, by the control system responsive to identifying that the online transaction is in a first state, a first value corresponding to information of the computing device. The method can include obtaining, by the control system responsive to identifying that the online transaction is in the first state, a first look-up value corresponding to the first value. The method can include selecting, by the control system, a first routing policy based on comparing the first value with the first look-up value. The method can include determining, by the control system responsive to identifying that the online transaction is in a second state, a second value from a field of the online transaction. The method can include obtaining, by the control system responsive to identifying that the online transaction is in the second state, a corresponding second look-up value corresponding to the second value. The method can include selecting, by the control system, a second routing policy based on comparing the second value with the second look-up value. The method can include determining, by the control system, to interrupt the online transaction based on detecting a presence of a match between at least one of the first value and the first look-up value or the second value and the second look-up value. The method can include interrupting, by the control system responsive to the determination, the online transaction to direct the online transaction to a resolving state according to either the first routing policy or second routing policy.

The method can include intercepting, by the control system, network traffic originated from the computing device to identify the first value corresponding to the information of the computing device.

The information of the computing device can include an IP address of the computing device that initiated the online transaction.

The method can include determining, by the control system, a geographic location of the computing device as the first value according to the information of the computing device. The method can include obtaining, by the control system, a list of flagged geographic locations as the first look-up value. The method can include determining the presence of the match between the first value and the first look-up value by identifying that the geographic location of the computing device is located in one of the flagged geographic locations. The method can include directing, by the control system according to the first routing policy, the online transaction to the resolving state including at least one of blocking the online transaction or initiating at least one further authentication process to be performed through the computing device.

The method can include determining, by the control system according to the information of the computing device, a connection type through which the computing device initiated the online transaction as the first value. The method can include obtaining, by the control system, a list of flagged connection types as of the first look-up value. The method can include determining the presence of the match between the first value and the first look-up value by identifying that the connection type is among one of the flagged connection types. The method can include directing, by the control system according to the first routing policy, the online transaction to the resolving state including at least one of blocking the online transaction or initiating at least one further authentication process to be performed through the computing device.

The field of the online transaction can include at least one of: a first name field, a last name field, an organization name field, a domain name field, and a phone number field.

The method can include obtaining, by the control system, responsive to identifying the second value corresponding to a value for at least one of a first name field or a last name field, a list of flagged first names or last names as the second look-up value. The method can include determining the presence of the match between the second value and the second look-up value by identifying that the second value is one of the flagged first names or last names. The method can include directing, by the control system according to the second routing policy, the online transaction to the resolving state including at least one of blocking the online transaction or initiating at least one further authentication process to be performed through the computing device.

The method can include obtaining, by the control system, responsive to identifying the second value corresponding to a value for an organization name field, a list of flagged first names or last names as the second look-up value. The method can include determining the presence of the match between the second value and the second look-up value by identifying that the second value is one of the flagged first names or last names. The method can include directing, by the control system according to the second routing policy, the online transaction to the resolving state including at least one of blocking the online transaction or initiating at least one further authentication process to be performed through the computing device.

The method can include obtaining, by the control system, responsive to identifying the second value corresponding to a value for a phone number field, a list of flagged phone number digits as the second look-up value. The method can include determining the presence of the match between the second value and the second look-up value by identifying that a number of digits of the second value matches one of the flagged phone number digits. The method can include directing, by the control system according to the second routing policy, the online transaction to the resolving state including at least one of blocking the online transaction or initiating at least one further authentication process to be performed through the computing device.

The method can include allowing, by the control system responsive to detecting an absence of the match between the first value and the first look-up value, the online transaction to proceed to the second state. The control system can allow the online transaction to proceed to the second state in accordance with the first routing policy. The method can include according to the second routing policy, directing, by the control system responsive to detecting the presence of the match between the second value and the second look-up value, the online transaction to the resolving state including at least one of blocking the online transaction or initiating at least one further authentication process to be performed through the computing device.

At least one aspect of this disclosure is directed to a system for detecting fraudulent transactions. The system can include a control system including one or more processors and memory. The control system can detect an online transaction initiated by a computing device. The control system can determine, responsive to identifying that the online transaction is in a first state, a first value corresponding to information of the computing device. The control system can obtain, responsive to identifying that the online transaction is in the first state, a first look-up value corresponding to the first value. The control system can select a first routing policy based on comparing the first value with the first look-up value. The control system can determine, responsive to identifying that the online transaction is in a second state, a second value from a field of the online transaction. The control system can obtain, responsive to identifying that the online transaction is in the second state, a corresponding second look-up value corresponding to the second value. The control system can select a second routing policy based on comparing the second value with the second look-up value. The control system can determine to interrupt the online transaction based on detecting a presence of a match between at least one of the first value and the first look-up value or the second value and the second look-up value. The control system can interrupt, responsive to the determination, the online transaction to direct the online transaction to a resolving state according to either the first routing policy or second routing policy.

The control system can intercept network traffic originated from the computing device to identify the first value corresponding to the information of the computing device.

The information of the computing device can include an IP address of the computing device that initiated the online transaction.

The control system can further determine a geographic location of the computing device as the first value according to the information of the computing device. The control system can further obtain a list of flagged geographic locations as the first look-up value. The control system can further determine the presence of the match between the first value and the first look-up value by identifying that the geographic location of the computing device is located in one of the flagged geographic locations. The control system can further direct, according to the first routing policy, the online transaction to the resolving state including at least one of blocking the online transaction or initiating at least one further authentication process to be performed through the computing device.

The control system can determine, according to the information of the computing device, a connection type through which the computing device initiated the online transaction as the first value. The control system can obtain a list of flagged connection types as of the first look-up value. The control system can determine the presence of the match between the first value and the first look-up value by identifying that the connection type is among one of the flagged connection types. The control system can direct, according to the first routing policy, the online transaction to the resolving state including at least one of blocking the online transaction or initiating at least one further authentication process to be performed through the computing device.

The field of the online transaction can include at least one of: a first name field, a last name field, an organization name field, a domain name field, and a phone number field.

The control system can obtain, responsive to identifying the second value corresponding to a value for at least one of a first name field or a last name field, a list of flagged first names or last names as the second look-up value. The control system can determine the presence of the match between the second value and the second look-up value by identifying that the second value is one of the flagged first names or last names. The control system can further direct, according to the second routing policy, the online transaction to the resolving state including at least one of blocking the online transaction or initiating at least one further authentication process to be performed through the computing device.

The control system can obtain, responsive to identifying the second value corresponding to a value for an organization name field, a list of flagged first names or last names as the second look-up value. The control system can further determine the presence of the match between the second value and the second look-up value by identifying that the second value is one of the flagged first names or last names. The control system can further direct, according to the second routing policy, the online transaction to the resolving state including at least one of blocking the online transaction or initiating at least one further authentication process to be performed through the computing device.

The control system can obtain, responsive to identifying the second value corresponding to a value for a phone number field, a list of flagged phone number digits as the second look-up value. The control system can determine the presence of the match between the second value and the second look-up value by identifying that a number of digits of the second value matches one of the flagged phone number digits. The control system can direct, according to the second routing policy, the online transaction to the resolving state including at least one of blocking the online transaction or initiating at least one further authentication process to be performed through the computing device.

The control system can allow, responsive to detecting an absence of the match between the first value and the first look-up value, the online transaction to proceed to the second state according to the first routing policy. The control system can further direct, by the control system responsive to detecting the presence of the match between the second value and the second look-up value, the online transaction to the resolving state according to the second routing policy. The resolving state includes at least one of blocking the online transaction or initiating at least one further authentication process to be performed through the computing device.

### BRIEF DESCRIPTION OF THE DRAWINGS

The details of one or more embodiments of the subject matter described in this specification are set forth in the accompanying drawings and the description below. Other features, aspects, and advantages of the subject matter will become apparent from the description, the drawings, and the claims.

FIG. 1 is an illustrative block diagram of an example embodiment of a system for detecting fraudulent transactions.

FIG. 2 is an illustrative block diagram of an example embodiment of a method for detecting fraudulent transactions.

FIG. 3A is a block diagram depicting an embodiment of a network environment comprising client device in communication with server device;

FIG. 3B is a block diagram depicting a cloud computing environment comprising client device in communication with cloud service providers;

FIGS. 3C and 3D are block diagrams depicting embodiments of computing devices useful in connection with the methods and systems described herein.

### DETAILED DESCRIPTION OF THE DISCLOSURE

A cloud service can provide a service or resource over a network, such as the Internet. Cloud services can include Software as a Service (“SaaS”), Platform as a Service (“PaaS”), or Infrastructure as a Service (“IaaS”). SaaS can include a software distribution model in which an application can be hosted by a vendor or service provider and made available to customers over the network. PaaS can include the delivery of an operating system and associated services of the network without downloading or installing the operating system. IaaS can include outsourcing equipment used to support operations, including storage, hardware, servers and network components, which can be accessed over the network.

Due to limited hardware resources, network resources, or other computing related resources, companies can outsource their information technology (“IT”) services to outside IT service providers. IT service providers can use software tools to provide IT support by facilitating the monitoring, service, and configuration of computing devices of their customers.

A web application (e.g., a self-hosted remote desktop software application) may provide a platform, bridge, or interface executing as a cloud service (e.g., SaaS) between a receiver computing device and one or more IT service providers. The web application can be available for both the receiver computing device and the IT service providers in terms of receiving or providing IT support. For example, upon detecting a request (e.g., from the receiver computing device), the web application can route, forward, or otherwise provide the request to one of the IT service providers to allow a technician computing device of the IT service provider to remotely modify the configuration of the receiver computing device.

Such a web application can be available for use upon purchasing a certified license via an online transaction. In some instances, a technician computing device, via a fraudulent online transaction, can purchase the web application and claim to offer a legitimate technical support service to a receiver computing device. Once connected to the receiver computing device, the fraudulent technician computing device can do things that can negatively harm the receiver computing device, or a user of the receiver computing device (e.g., exposing private information of the user, misusing the receiver computing device for other purposes not authorized by the user, installing malware, etc.). Harm to the receiving computing device can installing malicious software that disables functionality of the receiver computing device, encrypting storage on the receiver computing device, or commandeering processor or memory resources of the receiving computing device to perform computing tasks unbeknownst to the user of the receiver computing device. Systems that do not implement the methods disclosed herein may not detect such a fraudulent online transaction until the online transaction has been completed because, for example, valid payment information may be used for the fraudulent online transaction. Accordingly, the fraudulent computing device may use the web application in a manner that negatively harms the receiver computing device and/or the corresponding user. Further, in spite of detecting the fraudulent online transaction, a merchant selling the web application may suffer a chargeback, and even corresponding fines issued by banks, which can financially impact the merchant. These fraudulent transactions can consume excessive computing resources (e.g., processor cycles, memory or storage usage, cache usage, input/output interface requests, or read/write actions) or network resources (e.g., network bandwidth), or otherwise waste limited computing or network resources. The excessive consumption or waste of computing or network resources can introduce delays or latency when executing valid electronic transactions.

The systems and methods of this disclosure provide the technical solution to detect or prevent such fraudulent transactions, thereby reducing, mitigating or preventing excess or wasted consumption of computing or network resources in information technology infrastructures or receiver computing devices. The control system of this disclosure can detect an online transaction initiated by a computing system. In response to identifying that the online transaction is in a first state, the control system can determine a first value corresponding to information of the computing system. For example, the first state can correspond to a state of the online transaction in which the control system has detected an item being selected (e.g., for purchase) and no field value being entered. In another example, the first state can correspond to a state of the online transaction prior to any of the field values being entered (e.g., independent from inputs of the computing device). Upon identifying the online transaction is in the first state, the control system can obtain a first look-up value corresponding to the first value. Based on a comparison between the first value (given the online transaction in the first state) and the first look-up value, the system can select a first routing policy from multiple routing policies. For example, the system can determine to interrupt the online transaction based on detecting the presence of a match between the first value and the first look-up value. Upon determining to interrupt the online transaction, the control system can direct the online transaction to a resolving state according to the first routing policy. In some instances, the control system may determine not to interrupt the online transaction in the first state, which can cause the online transaction to proceed to a second state. For example, the second state can correspond to a state of the online transaction in which the control system has detected at least one field value being entered. In response to identifying that the online transaction is in the second state, the control system can determine a second value corresponding to one or more field values of the online transaction, and then obtain a second look-up value corresponding to the second value. Based on a comparison between the second value (given the online transaction in the second state) and the second look-up value, the system can select a second routing policy from the multiple routing policies. For example, the system can determine to interrupt the online transaction based on detecting the presence of a match between the second value and the second look-up value. Upon determining to interrupt the online transaction, the control system can direct the online transaction to a resolving state according to the second routing policy.

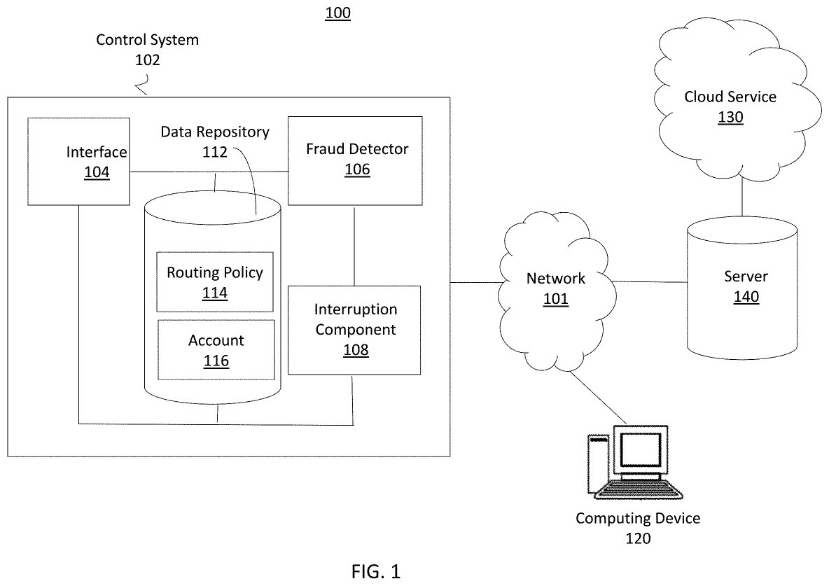

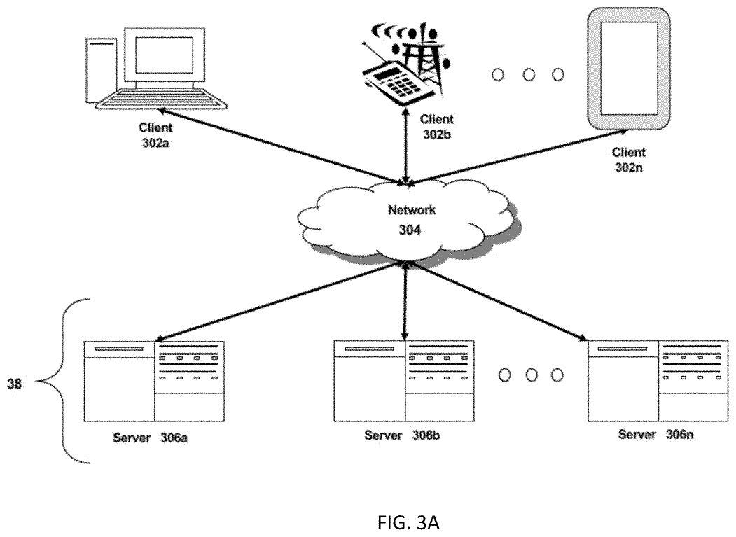

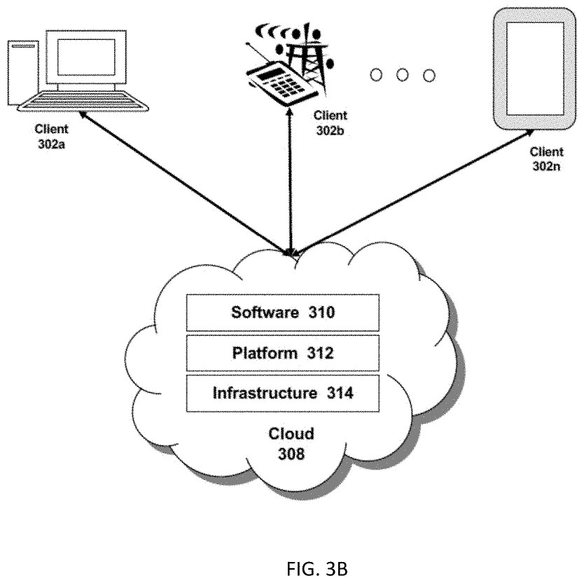

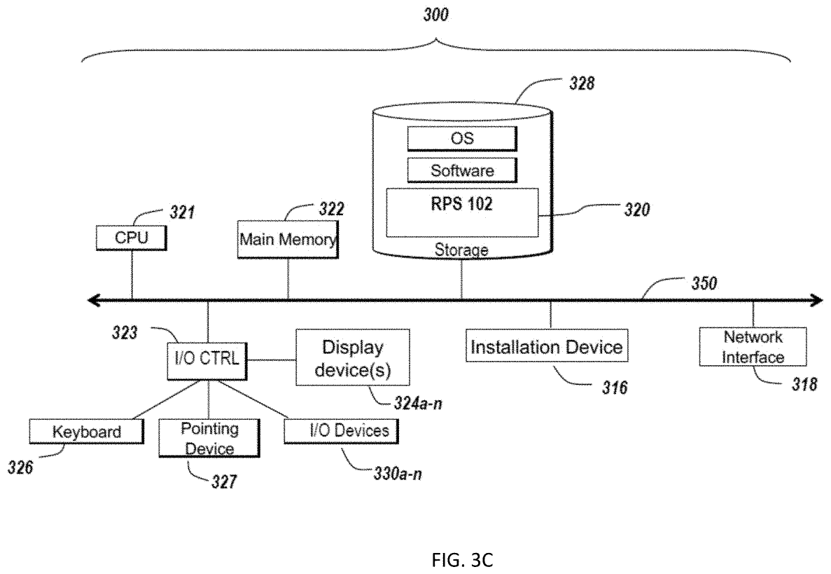

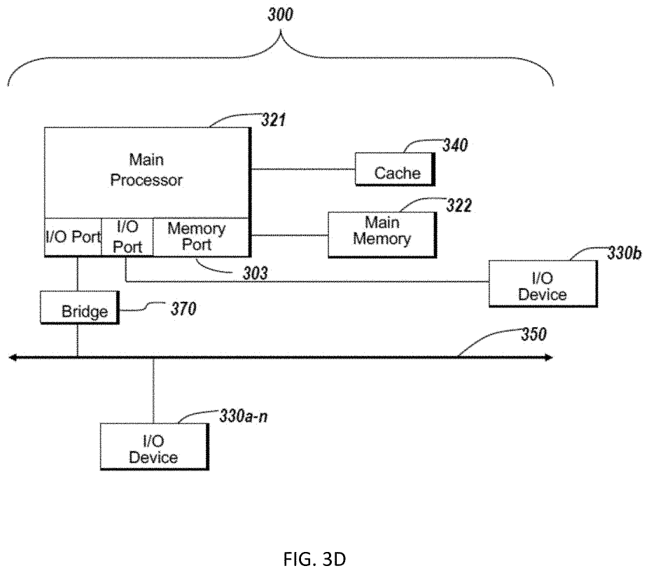

Referring now to FIG. 1, an illustrative block diagram of an example embodiment of a system 100 for detecting fraudulent transactions is provided. In brief overview, the system 100 can include a control system 102. The system 100 can include, access or interact with one or more of a computing device 120. The system 100 can include, access or interact with one or more cloud services 130 through one or more of a server 140. The components or functions of the system 100 (e.g., 102, 120, 130, and 140) may communicate with one another via one or more networks 101. The system 100 can include one or more component or function depicted in FIGS. 3A-3D.

The control system 102 can be executed by one or more servers (e.g., server 306a) or a cloud 308 or on one or more processors (e.g., main processor 321). The control system 102 can include an interface 104 designed and constructed to communicate with one or more of the computing device 120, and the server 140. The interface 104 can include a port, networking protocol, or application programming interface. The interface 104 can include or provide a graphical user interface.

The computing device 120 can include, for example, a desktop, laptop, tablet computing, smartwatch, wearable device, augmented reality device, or virtual reality device. The computing device 120 can include a telecommunications device. The computing device 120 can include input devices such as a keyboard, touchpad, mouse, pointing device, joystick or voice input interface. The computing device 120 can include a virtual machine that is executed on a server, or a virtual machine executed in a cloud service or cloud computing environment.

The computing device 120 can be local to an entity, organization, office or location. The computing device 120 can perform one or more online transactions to purchase or otherwise access the cloud service 130. For example, upon being granted to access the cloud service 130, the computing device 120 can use a support ticket, routed by the cloud service 130, to access the cloud service 130 and use the cloud service 130 to access a receiver computing device that initiates the support ticket in order to receive support from an agent or support technician that uses the computing device 120.

The control system 102 can include, interface with or otherwise communicate with at least one interface 104, at least one fraud detector 106, at least one interruption component 108, and at least one data repository 112. The data repository 112 can include one or more data structures, data bases, or data files, such as one or more routing policies 114.

The interface 104, fraud detector 106, or interruption component 108 can each include at least one processing unit or other logic device such as programmable logic array engine, or module configured to communicate with the database repository 112. The interface 104, fraud detector 106, interruption component 108, and data repository 112 can be separate components, a single component, or part of the control system 102. The system 100 and its components, such as a control system 102, can include hardware elements, such as one or more processors, logic devices, or circuits.

The interface 104 can include any type of interface configured to facilitate communication between one or more component, system or device of system 100. The interface 104 can be configured to facilitate communication or interaction between components or elements of the control system 102. The interface 104 can present, display or otherwise provide a graphical user interface or other user interface to facilitate user interaction with the control system 102.

The interface 104 can include, communicate with or execute one or more application programming interfaces (“APIs”). The APIs can be configured to interact or interface with the computing device 120. The interface 104 can include or utilize one or more cloud application programming interfaces. The interface can include or be based on, for example, a cloud API, Open Cloud Computing Interface (“OCCI”), or representation state transfer (“REST”). Responses and requests can be received or transmitted via the interface 104 using one or more protocol or language, such as, e.g., WL, HTML, JSON, HTTP, or SSL. Responses and requests can be received or transmitted via the interface 104 using one or more protocol or language, such as, e.g., XML, HTML, JSON, HTTP, or SSL.

The control system 102 can be intermediary to the computing device 120 and the server 140. In some cases, the computing device 120, when implemented as a technician computing device, may interact with a receiver computing device through the server 140 that executes the cloud service 130. For example, the technician computing device 120 may access, use, or otherwise interact with the cloud service 130 to interact with the computing device.

The fraud detector 106 can utilize the interface 104 to detect, pinpoint, or otherwise identify an online transaction initiated by the computing device 120. The fraud detector 106 can intercept or monitor network traffic originated (or received) from the computing device 120 and/or transmitting to the server 140 executing the cloud service 130. For example, the server 140 can execute a web page or portal accessible for the computing device 120 to use the cloud service 130 via an authenticated or authorized online transaction. The online transaction can include a number of different states. Each of the states of the online transaction can correspond to a screen or representation of the web page, each of which is responsive to one another according to predefined rule or user's inputs. For example, a first state of the online transaction can correspond to a screen of the web page displaying one or more of the cloud service 130 to be selected; and a second state of the online transaction, responsive to a cloud service 130 being selected, can correspond to a screen of the web page displaying a number of fields (e.g., a first name field, a last name field, a phone number field, an organization name field, among others) to be entered. The network traffic can refer to a sequence of digitally encoded coherent signals, or packets of data or data packets used to transmit or receive information that is in the process of being transmitted. The data packets can include a header and a payload containing data. The fraud detector 106 can parse or process the header or payload information associated with data packets of the network traffic to detect the computing device 120 initiating the online transaction. For example, the fraud detector 106 can parse the network traffic to detect the initiation of the online transaction and determine, detect, or otherwise identify a current state of the online transaction.

In response to identifying that the online transaction is in the first state, the fraud detector 106 can determine a first value corresponding to information of the computing device 120. The information can include physical or virtual location information of the computing device 120, for example, where the computing device 120 initiated the online transaction. The location information can include an IP address via which the computing device 120 initiated the online transaction. Alternatively or additionally, the information can include time information of the computing device 120, for example, when the computing device 120 initiated the online transaction. The information can include account information of the computing device 120, for example, which of a number of preauthorized accounts 116 is used by the computing device to initiate the online transaction. The control system 100 can store or manage the preauthorized accounts 116 in the data repository 112. Upon identifying the IP address of the computing device 120, the fraud detector 106 can trace back or otherwise determine a geographic location of the computing device 120 to be the first value.

Upon identifying the IP address of the computing device 120, the fraud detector 106 can determine a connection type through which the computing device initiated the online transaction as the first value. While identifying the IP address of the computing device 120, the fraud detector 106 can further determine or identify whether the network traffic (originated from the computing device 120) is established using an encrypted layered tunneling protocol. Examples of encrypted layered tunneling protocols can include internet security protocol security, point-to-point tunneling protocol, layer two tunneling protocol, internet key exchange version 2, secure socket tunneling protocol, or openvpn. If so, the fraud detector 106 can determine the first value to be a virtual private network (VPN). If not, the fraud detector 106 can determine the first value to be at least one of: a fixed broadband Internet, a mobile Internet, a dial-up network, a direct network, and a local area network.

Further, responsive to identifying that the online transaction is in the first state, the fraud detector 106 can search, request, or otherwise obtain a first look-up value corresponding to the first value. The fraud detector 106 can communicate with one or more network entities to obtain the first look-up value. The first look-up value can correspond to one or more first values extracted from previously performed online transactions. Examples of the network entities can include an administrative account of the one or more cloud services 130, a particular cloud service that the computing device 120 intended to access via online transactions, and a publicly facing user interface of the one or more cloud services 130. The fraud detector 106 can interface with the network entities to parse, ingest, or otherwise process one or more electronic activities (e.g., an email, a phone call, a text message, an instant message (across various platforms), and so forth) to obtain the first look-up value corresponding to the first value.

In response to obtaining the first look-up value, the fraud detector 106 can compare the first value with the first look-up value. The fraud detector 106, based on the comparison, can select a first routing policy from a number of routing policies. The fraud detector 106 can predefine and store the number of routing policies in a data structure (e.g., routing policy 114 data structure in the data repository 112). In some embodiments, the fraud detector 106 can compare the first value and first look-up value to determine the presence of a match between the first value and the first look-up value. If the fraud detector 106 determines that there is a match between the first value and the first look-up value, the fraud detector 106 can select the first routing policy to be interrupting the online transaction by directing the online transaction to a resolving state. The fraud detector 106, upon selecting a routing policy as an interrupting one, can cause the interruption component 108 to interrupt the online transaction. On the other hand, if the fraud detector 106 determines that there is no match between the first value and the first look-up value, the fraud detector 106 can select the first routing policy to be continuing the online transaction by directing the online transaction to the next state. The fraud detector 106, upon selecting a routing policy as an continuing one, can continue the online transaction without interfacing with the interruption component 108.

For example, in response to determining that a type of the first value corresponds to a geographic location of the computing device 120, the fraud detector 106 can obtain one or more of a list of flagged geographic locations as the first look-up value (e.g., countries that are previously identified and dynamically managed by at least one of the above-discussed network entities). Accordingly, the fraud detector 106 can compare the geographic location of the computing device 120 with each of the flagged geographic locations (first look-up value). If there is a match, the fraud detector 106 can select the first routing policy configured to direct the online transaction to a resolving state. The resolving state can include blocking the online transaction. For example, the first routing policy can cause the interruption component 108 to block, deny, or hijack all the data packets that the computing device 120 transmits to the server 140 (e.g., disabling, for the computing device 120, the web page executed by the server 140). The resolving state can include initiating one or more further authentication processes to be performed through the computing device 120. For example, the first routing policy can cause the interruption component 108 to request, demand, or force the computing device 120 to follow a series of verification steps, call a customer service in relation to the cloud service 130, among others. The fraud detector 106 can determine whether the computing device 120 has followed and passed the further authentication processes. If so, the fraud detector 106 can continue the online transaction to the next state. However, if not, the fraud detector 106 can block the online transaction.

In another example, in response to determining that a type of the first value corresponds to a connection type of the computing device 120, the fraud detector 106 can obtain one or more of a list of flagged connection types as the first look-up value (e.g., connection types that are previously identified and dynamically managed by at least one of the above-discussed endpoints). Accordingly, the fraud detector 106 can compare the geographic location of the computing device 120 with each of the flagged geographic locations (first look-up value). If there is a match, the fraud detector 106 can select the first routing policy configured to direct the online transaction to a resolving state. The resolving state can include blocking the online transaction. For example, the first routing policy can cause the interruption component 108 to block, deny, or hijack all the data packets that the computing device 120 transmits to the server 140 (e.g., disabling, for the computing device 120, the web page executed by the server 140). The resolving state can include initiating one or more further authentication processes to be performed through the computing device 120. For example, the first routing policy can cause the interruption component 108 to request, demand, or force the computing device 120 to follow a series of verification steps, call a customer service in relation to the cloud service 130, among others. The fraud detector 106 can determine whether the computing device 120 has followed and passed the further authentication processes. If so, the fraud detector 106 can continue the online transaction to the next state. However, if not, the fraud detector 106 can block the online transaction.

The control system 102 can dynamically monitor the multiple states of the online transaction. In response to detecting a fraudulent activity at any of the multiple states, the control system 102 can interrupt the online transaction by directing the online transaction to a resolving state according to the routing policy corresponding to the current state. In the above example, although the fraud detector 106 allows the online transaction to continue to the successive state(s), the fraud detector 106 can interrupt the online transaction at any of the successive states in response to detecting an fraudulent activity.

In response to identifying that the online transaction is in a second state, the fraud detector 106 can determine a second value from one or more fields of the online transaction. In some embodiments, the second state can correspond to a state of the online transaction in which the fraud detector 106 has detected at least one value that has been entered into one or more fields of the online transaction. The fields of the online transaction can include at least one of: a first name field, a last name field, an organization name field, a domain name field, and a phone number field.

Further, in response to identifying that the online transaction is in the second state, the fraud detector 106 can search, request, or otherwise obtain a second look-up value corresponding to the first value. The fraud detector 106 can communicate with one or more of the above-discussed network entities to obtain the second look-up value. The second look-up value can correspond to one or more second values extracted from previously performed online transactions. In an example where the fraud detector 106 determines the second value as a value for a first name field, the second look-up value can be one or more first names used in the previous online transactions. In some embodiments, the fraud detector 106 can interface with the network entities to parse, ingest, or otherwise process one or more electronic activities (e.g., an email, a phone call, a text message, an instant message (across various platforms), and so forth) to obtain the second look-up value corresponding to the second value.

In response to obtaining the second look-up value, the fraud detector 106 can compare the second value with the second look-up value. The fraud detector 106, based on the comparison, can select a second routing policy from the number of routing policies. The fraud detector 106 can predefine and store the number of routing policies in a data structure (e.g., the data repository 112). In some embodiments, the fraud detector 106 can compare the second value and second look-up value to determine the presence of a match between the second value and the second look-up value. If the fraud detector 106 determines that there is a match between the second value and the second look-up value, the fraud detector 106 can select the second routing policy to be interrupting the online transaction by directing the online transaction to a resolving state. The fraud detector 106, upon selecting a routing policy as an interrupting one, can cause the interruption component 108 to interrupt the online transaction. On the other hand, if the fraud detector 106 determines that there is no match between the second value and the second look-up value, the fraud detector 106 can select the second routing policy to be continuing the online transaction by directing the online transaction to the next state. The fraud detector 106, upon selecting a routing policy as an continuing one, can continue the online transaction without interfacing with the interruption component 108.

For example, in response to determining that a type of the second value corresponds to at least one of a first name field or a last name field, the fraud detector 106 can obtain one or more of a list of flagged first or last names as the second look-up value. Accordingly, the fraud detector 106 can compare the entered first or last name with each of the flagged first or last names (second look-up value). If there is a match, the fraud detector 106 can select the second routing policy configured to direct the online transaction to a resolving state. The resolving state can include blocking the online transaction. For example, the second routing policy can cause the interruption component 108 to block, deny, or hijack all the data packets that the computing device 120 transmits to the server 140 (e.g., disabling, for the computing device 120, the web page executed by the server 140). The resolving state can include initiating one or more further authentication processes to be performed through the computing device 120. For example, the second routing policy can cause the interruption component 108 to request, demand, or force the computing device 120 to follow a series of verification steps, call a customer service in relation to the cloud service 130, among others. The fraud detector 106 can determine whether the computing device 120 has followed and passed the further authentication processes. If so, the fraud detector 106 can continue the online transaction to the next state. However, if not, the fraud detector 106 can block the online transaction.

In another example, in response to determining that a type of the second value corresponds to an organization name field, the fraud detector 106 can obtain one or more of a list of flagged first or last names as the second look-up value. Accordingly, the fraud detector 106 can compare the entered organization name with each of the flagged first or last names (second look-up value). If there is a match, the fraud detector 106 can select the second routing policy configured to direct the online transaction to a resolving state. The resolving state can include blocking the online transaction. For example, the second routing policy can cause the interruption component 108 to block, deny, or hijack all the data packets that the computing device 120 transmits to the server 140 (e.g., disabling, for the computing device 120, the web page executed by the server 140). The resolving state can include initiating one or more further authentication processes to be performed through the computing device 120. For example, the second routing policy can cause the interruption component 108 to request, demand, or force the computing device 120 to follow a series of verification steps, call a customer service in relation to the cloud service 130, among others. The fraud detector 106 can determine whether the computing device 120 has followed and passed the further authentication processes. If so, the fraud detector 106 can continue the online transaction to the next state. However, if not, the fraud detector 106 can block the online transaction.

In yet another example, in response to determining that a type of the second value corresponds to a phone number field, the fraud detector 106 can obtain one or more of a list of flagged phone number digits as the second look-up value. Accordingly, the fraud detector 106 can compare the number of digits of the entered phone number with each of the flagged phone number digits (second look-up value). If there is a match, the fraud detector 106 can select the second routing policy configured to direct the online transaction to a resolving state. The resolving state can include blocking the online transaction. For example, the second routing policy can cause the interruption component 108 to block, deny, or hijack all the data packets that the computing device 120 transmits to the server 140 (e.g., disabling, for the computing device 120, the web page executed by the server 140). The resolving state can include initiating one or more further authentication processes to be performed through the computing device 120. For example, the second routing policy can cause the interruption component 108 to request, demand, or force the computing device 120 to follow a series of verification steps, call a customer service in relation to the cloud service 130, among others. The fraud detector 106 can determine whether the computing device 120 has followed and passed the further authentication processes. If so, the fraud detector 106 can continue the online transaction to the next state. However, if not, the fraud detector 106 can block the online transaction.

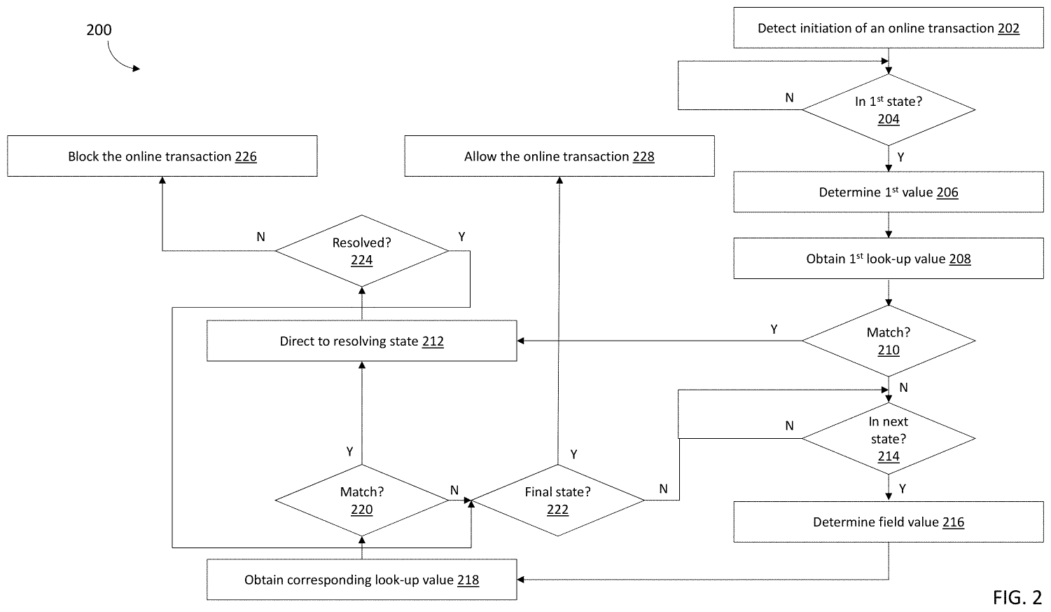

Referring to FIG. 2, depicted is a flow diagram of one embodiment of a method 200 for detecting fraudulent transactions. The functionalities or operations of the method 200 may be implemented using, or performed by, one or more components depicted in FIG. 1, including, e.g., a control system or fraud detector.

In brief overview, a control system can detect the initiation of an online transaction at operation 202. At operation 204, the control system can monitor to determine whether the online transaction is in a first state. If not, the control system can continue monitoring whether the online transaction is in the first state (operation 204); and if so, the control system can determine a first value (operation 206). Next at operation 208, the control system can obtain a first look-up value. At operation 210, the control system can determine whether a match between the first value and first look-up value exists. If so, the control system can direct the online transaction to a resolving state (operation 212); and if not, the control system can monitor to determine whether the online transaction is in a next state (operation 214). If the control system determines that the online transaction is not in the next state, the control system can continue monitoring whether the online transaction is in the next state (operation 214). On the other hand, if the control system determines that the online transaction is in the next state, the control system can determine a field value (operation 216). Next at operation 218, the control system can obtain one or more look-up values corresponding to the field value. In response, the control system can determine a match between the field value and one or more look-up values at operation 220. If there is no match, the control system can determine whether the online transaction is in a final state (operation 222). If so, the control system can allow the online transaction (operation 228); and if not, the method may proceed again to operation 214. Referring again to operation 220, if there is a match, the method can proceed to operation 212 to direct the online transaction to the resolving state. Upon being in the resolving state, the control system can determine whether one or more potential fraudulent activities have been resolved (operation 224). If so, the method can proceed to operation 228 to allow the online transaction; and if not, the control system can block the online transaction at operation 226.

Referring to operation 202, the control system can detect, pinpoint, or otherwise identify an online transaction initiated by a computing device. The computing device can initiate the online transaction intending to access a cloud service executed on a server. In some embodiments, the control system can intercept or monitor network traffic originated (or received) from the computing device and/or transmitting to the server executing the cloud service. The cloud service can include a web application functioning as a platform, bridge, or interface between a receiver computing device and one or more IT service providers. Upon being granted, authorized, or licensed via the online transaction to access the cloud service, the computing device can function as one of the IT service providers to provide the receiver computing device with IT support. The online transaction can be performed (e.g., initiated) through a web application (e.g., a web page, a portal, etc.) executing on the server. By monitoring the network traffic, the control system can determine that the online transaction has been initiated. For example, the control system can detect the initiation of the online transaction based on determining that a time duration for which the computing device remains at the web page satisfies a threshold (e.g., greater than a predefined time duration).

Referring to operation 204, the control system can monitor to determine whether the online transaction is in the first state. For example, the first state can correspond to a state of the online transaction in which the control system has detected an item being selected (e.g., for purchase) and no field value being entered. In another example, the first state can correspond to a state of the online transaction prior to any of the field values being entered (e.g., independent from inputs of the computing device). Continuing with the above example, in response to the control system detecting that an item on the web page corresponding to the cloud service is selected, the control system can determine that the initiated online transaction has entered into the first state. Alternatively or additionally to detecting the selection of an item on the web page, the control system may detect no filed values being entered to determine that the online transaction enters or stays in the first state.

In response to identifying that the online transaction is in the first state, the control system can determine the first value corresponding to information of the computing system (operation 206). Based on the first value, the control system can obtain the first look-up value (operation 208). The first value can correspond to information of the computing device that initiated the online transaction. The information of the computing device can include physical or virtual location information of the computing device, for example, where the computing device initiated the online transaction. The location information can include an IP address via which the computing device initiated the online transaction. In response to determining the IP address, the control system can determine the first value to be a geographic location of the computing device, a connection type via which the computing device initiated the online transaction, among others. Based on the determined first value, the control system can obtain one or more first look-up values. For example, corresponding to the geographic location of the computing device, the control system can obtain a list of flagged geographic locations as the first look-up value. In another example, corresponding to the connection type used by the computing device, the control system can obtain a list of flagged connection types as the first look-up value.

Upon determining the first value and obtaining the corresponding first look-up value, the control system can determine whether a match exists between the first value and first look-up value (operation 210). Based on the comparison at operation 210, the control system can accordingly select a routing policy to direct the online transaction. For example, if the control system determines that the absence of a match between the first value and first look-up value (“N” route from operation 210), the control system can select a routing policy that allows the online transaction to proceed to the next state. As such, the control system can further determine whether the online transaction has entered into the next state (operation 214). The control system can make such a determination based on detecting whether one or more fields in the second state of the online transaction has been filled up with respective values (hereinafter “field values”). Upon determining that the online transaction is in the next state (“Y” route from operation 214), the control system can determine the field value being entered (operation 216); and upon determining that the online transaction is not in the next state (“N” route from operation 214), the control system can continue monitoring the state of the online transaction. Referring again to operation 210, if the control system determines that the presence of a match between the first value and first look-up value (“Y” route from operation 210), the control system can select a routing policy that directs the online transaction to the resolving state (operation 212), which shall be discussed below.

In some embodiments, the field value can include the value entered into a field of the online transaction. For example, the field can include at least one of: a first name field, a last name field, an organization name field, a domain name field, and a phone number field. In some embodiments, the field can include a payment-related field such as, for example, an account number, a credit card number, a routing number, a bank name, among others. In response to determining the one or more field values, the control system can obtain corresponding look-up values (operation 218). For example, in response to determining a value being entered into a first name field (a first name field value), the control system can obtain a list of flagged first names as the look-up values. In another example, in response to determining a value being entered into a last name field (a last name field value), the control system can obtain a list of flagged last names as the look-up values. In yet another example, in response to determining a value being entered into an organization name field (an organization name field value), the control system can obtain a list of flagged first or last names as the look-up values. In yet another example, in response to determining a value being entered into a phone number name field (a phone number field value), the control system can obtain a list of flagged phone number digits as the look-up values. In yet another example, in response to determining a value being entered into a payment-related field (a payment field value), the control system can obtain a list of flagged payment values (e.g., flagged credit card numbers) as the look-up values.

Upon determining the field value and obtaining the corresponding look-up value, the control system can determine whether a match exists between the field value and corresponding look-up value (operation 220). Based on the comparison at operation 220, the control system can accordingly select a routing policy to direct the online transaction. For example, if the control system determines that the absence of a match between the field value and corresponding look-up value (“N” route from operation 220), the control system can select a routing policy to determine whether the current state is the final state of the online transaction (operation 222) prior to allowing the online transaction. The control system can identify the final state of the online transaction based on determining that one or more payment-related fields of the online transaction have been filled up with valid values. If the control system determines that the no match between the field value in the current state and the current state is the final state (“N” route from operation 220 and then “Y” route from operation 222), the control system can allow the online transaction (operation 228). If the control system determines that the no match between the field value in the current state and the current state is not the final state (“N” route from operation 220 and then “N” route from operation 222), the control system can continue monitoring whether the online transaction is in the next state (operation 214). If the control system determines that the presence of a match between the field value and corresponding look-up value (“Y” route from operation 220), the control system can select a routing policy to direct the online transaction to the resolving state (operation 212).

Referring again to operation 220, in the example where the field value is a first name field or a last name, the control system can compare the first or last name field value with each of the obtained flagged first or last names (corresponding look-up values) to determine whether there is a match. In another example where the field value is an organization name, the control system can compare the organization name field value with each of the obtained flagged first or last names (corresponding look-up values) to determine whether there is a match. In yet another example where the field value is a phone number, the control system can compare the number of digits of the phone number field value with each of the obtained flagged phone number digits (corresponding look-up values) to determine whether there is a match.

Referring now to operation 212, the resolving state can include initiating one or more further authentication processes to be performed through the computing device, among others. The control system can identify whether such further authentication processes have been performed to determine whether the potential fraudulent activity has been resolved (operation 224). If so, the control system can determine whether the current state is the final state prior to allowing the online transaction (“Y” route from operation 224 and then the determination operation at 222). On the other hand, if not, the resolving state can further include confirming the fraudulent activity and then blocking the online transaction (“N” route from operation 224).

Referring to FIG. 3A, an embodiment of a network environment that can be used in connection with the methods and systems described herein is depicted. In brief overview, the network environment includes one or more clients 302a-302n (also generally referred to as local machine(s) 302, client(s) 302, client node(s) 302, client machine(s) 302, client computer(s) 302, client device(s) 302, endpoint(s) 302, or endpoint node(s) 302) in communication with one or more servers 306a-306n (also generally referred to as server(s) 306, node 306, or remote machine(s) 306) via one or more networks 304. In some embodiments, a client 302 has the capacity to function as both a client node seeking access to resources provided by a server and as a server providing access to hosted resources for other clients 302a-302n.

Although FIG. 3A shows a network 304 between the clients 302 and the servers 306, the clients 302 and the servers 306 may be on the same network 304. In some embodiments, there are multiple networks 304 between the clients 302 and the servers 306. In one of these embodiments, a network 304′ (not shown) may be a private network and a network 304 may be a public network. In another of these embodiments, a network 304 may be a private network and a network 304′ a public network. In still another of these embodiments, networks 304 and 304′ may both be private networks.

The network 304 may be connected via wired or wireless links. Wired links may include Digital Subscriber Line (DSL), coaxial cable lines, or optical fiber lines. The wireless links may include BLUETOOTH, Wi-Fi, Worldwide Interoperability for Microwave Access (WiMAX), an infrared channel or satellite band. The wireless links may also include any cellular network standards used to communicate among mobile devices, including standards that qualify as 1G, 2G, 3G, or 4G. The network standards may qualify as one or more generation of mobile telecommunication standards by fulfilling a specification or standards such as the specifications maintained by International Telecommunication Union. The 3G standards, for example, may correspond to the International Mobile Telecommunications-2000 (IMT-2000) specification, and the 4G standards may correspond to the International Mobile Telecommunications Advanced (IMT-Advanced) specification. Examples of cellular network standards include AMPS, GSM, GPRS, UMTS, LTE, LTE Advanced, Mobile WiMAX, and WiMAX-Advanced. Cellular network standards may use various channel access methods e.g. FDMA, TDMA, CDMA, or SDMA. In some embodiments, different types of data may be transmitted via different links and standards. In other embodiments, the same types of data may be transmitted via different links and standards.

The network 304 may be any type and/or form of network. The geographical scope of the network 304 may vary widely and the network 304 can be a body area network (BAN), a personal area network (PAN), a local-area network (LAN), e.g. Intranet, a metropolitan area network (MAN), a wide area network (WAN), or the Internet. The topology of the network 304 may be of any form and may include, e.g., any of the following: point-to-point, bus, star, ring, mesh, or tree. The network 304 may be an overlay network which is virtual and sits on top of one or more layers of other networks 304′. The network 304 may be of any such network topology as known to those ordinarily skilled in the art capable of supporting the operations described herein. The network 304 may utilize different techniques and layers or stacks of protocols, including, e.g., the Ethernet protocol, the internet protocol suite (TCP/IP), the ATM (Asynchronous Transfer Mode) technique, the SONET (Synchronous Optical Networking) protocol, or the SDH (Synchronous Digital Hierarchy) protocol. The TCP/IP internet protocol suite may include application layer, transport layer, internet layer (including, e.g., IPv6), or the link layer. The network 304 may be a type of a broadcast network, a telecommunications network, a data communication network, or a computer network.

In some embodiments, the system may include multiple, logically-grouped servers 306. In one of these embodiments, the logical group of servers may be referred to as a server farm 38 or a machine farm 38. In another of these embodiments, the servers 306 may be geographically dispersed. In other embodiments, a machine farm 38 may be administered as a single entity. In still other embodiments, the machine farm 38 includes a plurality of machine farms 38. The servers 306 within each machine farm 38 can be heterogeneous—one or more of the servers 306 or machines 306 can operate according to one type of operating system platform (e.g., WINDOWS NT, manufactured by Microsoft Corp. of Redmond, Wash.), while one or more of the other servers 306 can operate on according to another type of operating system platform (e.g., Unix, Linux, or Mac OS X).

In one embodiment, servers 306 in the machine farm 38 may be stored in high-density rack systems, along with associated storage systems, and located in an enterprise data center. In this embodiment, consolidating the servers 306 in this way may improve system manageability, data security, the physical security of the system, and system performance by locating servers 306 and high performance storage systems on localized high performance networks. Centralizing the servers 306 and storage systems and coupling them with advanced system management tools allows more efficient use of server resources.

The servers 306 of each machine farm 38 do not need to be physically proximate to another server 306 in the same machine farm 38. Thus, the group of servers 306 logically grouped as a machine farm 38 may be interconnected using a wide-area network (WAN) connection or a metropolitan-area network (MAN) connection. For example, a machine farm 38 may include servers 306 physically located in different continents or different regions of a continent, country, state, city, campus, or room. Data transmission speeds between servers 306 in the machine farm 38 can be increased if the servers 306 are connected using a local-area network (LAN) connection or some form of direct connection. Additionally, a heterogeneous machine farm 38 may include one or more servers 306 operating according to a type of operating system, while one or more other servers 306 execute one or more types of hypervisors rather than operating systems. In these embodiments, hypervisors may be used to emulate virtual hardware, partition physical hardware, virtualize physical hardware, and execute virtual machines that provide access to computing environments, allowing multiple operating systems to run concurrently on a host computer. Native hypervisors may run directly on the host computer. Hypervisors may include VMware ESX/ESXi, manufactured by VMWare, Inc., of Palo Alto, Calif.; the Xen hypervisor, an open source product whose development is overseen by Citrix Systems, Inc.; the HYPER-V hypervisors provided by Microsoft or others. Hosted hypervisors may run within an operating system on a second software level. Examples of hosted hypervisors may include VMware Workstation and VIRTUALBOX.

Management of the machine farm 38 may be de-centralized. For example, one or more servers 306 may comprise components, subsystems and modules to support one or more management services for the machine farm 38. In one of these embodiments, one or more servers 306 provide functionality for management of dynamic data, including techniques for handling failover, data replication, and increasing the robustness of the machine farm 38. Each server 306 may communicate with a persistent store and, in some embodiments, with a dynamic store.

Server 306 may be a file server, application server, web server, proxy server, appliance, network appliance, gateway, gateway server, virtualization server, deployment server, SSL VPN server, or firewall. In one embodiment, the server 306 may be referred to as a remote machine or a node.

Referring to FIG. 3B, a cloud computing environment is depicted. A cloud computing environment may provide client 302 with one or more resources provided by a network environment. The cloud computing environment may include one or more clients 302a-302n, in communication with the cloud 308 over one or more networks 304. Clients 302 may include, e.g., thick clients, thin clients, and zero clients. A thick client may provide at least some functionality even when disconnected from the cloud 308 or servers 306. A thin client or a zero client may depend on the connection to the cloud 308 or server 306 to provide functionality. A zero client may depend on the cloud 308 or other networks 304 or servers 306 to retrieve operating system data for the client device. The cloud 308 may include back end platforms, e.g., servers 306, storage, server farms or data centers.

The cloud 308 may be public, private, or hybrid. Public clouds may include public servers 306 that are maintained by third parties to the clients 302 or the owners of the clients. The servers 306 may be located off-site in remote geographical locations as disclosed above or otherwise. Public clouds may be connected to the servers 306 over a public network. Private clouds may include private servers 306 that are physically maintained by clients 302 or owners of clients. Private clouds may be connected to the servers 306 over a private network 304. Hybrid clouds 308 may include both the private and public networks 304 and servers 306.

The cloud 308 may also include a cloud based delivery, e.g. Software as a Service (SaaS) 310, Platform as a Service (PaaS) 314, and Infrastructure as a Service (IaaS) 614. IaaS may refer to a user renting the use of infrastructure resources that are needed during a specified time period. IaaS providers may offer storage, networking, servers or virtualization resources from large pools, allowing the users to quickly scale up by accessing more resources as needed. Examples of IaaS include AMAZON WEB SERVICES provided by Amazon.com, Inc., of Seattle, Wash., RACKSPACE CLOUD provided by Rackspace US, Inc., of San Antonio, Tex., Google Compute Engine provided by Google Inc. of Mountain View, Calif., or RIGHTSCALE provided by RightScale, Inc., of Santa Barbara, Calif. PaaS providers may offer functionality provided by IaaS, including, e.g., storage, networking, servers or virtualization, as well as additional resources such as, e.g., the operating system, middleware, or runtime resources. Examples of PaaS include WINDOWS AZURE provided by Microsoft Corporation of Redmond, Wash., Google App Engine provided by Google Inc., and HEROKU provided by Heroku, Inc. of San Francisco, Calif. SaaS providers may offer the resources that PaaS provides, including storage, networking, servers, virtualization, operating system, middleware, or runtime resources. In some embodiments, SaaS providers may offer additional resources including, e.g., data and application resources. Examples of SaaS include GOOGLE APPS provided by Google Inc., SALESFORCE provided by Salesforce.com Inc. of San Francisco, Calif., or OFFICE 365 provided by Microsoft Corporation. Examples of SaaS may also include data storage providers, e.g. DROPBOX provided by Dropbox, Inc. of San Francisco, Calif., Microsoft SKYDRIVE provided by Microsoft Corporation, Google Drive provided by Google Inc., or Apple ICLOUD provided by Apple Inc. of Cupertino, Calif.

Clients 302 may access IaaS resources with one or more IaaS standards, including, e.g., Amazon Elastic Compute Cloud (EC2), Open Cloud Computing Interface (OCCI), Cloud Infrastructure Management Interface (CIMI), or OpenStack standards. Some IaaS standards may allow clients access to resources over HTTP, and may use Representational State Transfer (REST) protocol or Simple Object Access Protocol (SOAP). Clients 302 may access PaaS resources with different PaaS interfaces. Some PaaS interfaces use HTTP packages, standard Java APIs, JavaMail API, Java Data Objects (JDO), Java Persistence API (JPA), Python APIs, web integration APIs for different programming languages including, e.g., Rack for Ruby, WSGI for Python, or PSGI for Perl, or other APIs that may be built on REST, HTTP, XML, or other protocols. Clients 302 may access SaaS resources through the use of web-based user interfaces, provided by a web browser (e.g. GOOGLE CHROME, Microsoft INTERNET EXPLORER, or Mozilla Firefox provided by Mozilla Foundation of Mountain View, Calif.). Clients 302 may also access SaaS resources through smartphone or tablet applications, including, e.g., Salesforce Sales Cloud, or Google Drive app. Clients 302 may also access SaaS resources through the client operating system, including, e.g., Windows file system for DROPBOX.

In some embodiments, access to IaaS, PaaS, or SaaS resources may be authenticated. For example, a server or authentication server may authenticate a user via security certificates, HTTPS, or API keys. API keys may include various encryption standards such as, e.g., Advanced Encryption Standard (AES). Data resources may be sent over Transport Layer Security (TLS) or Secure Sockets Layer (SSL).

The client 302 and server 306 may be deployed as and/or executed on any type and form of computing device, e.g. a computer, network device or appliance capable of communicating on any type and form of network and performing the operations described herein. FIGS. 3C and 3D depict block diagrams of a computing device 300 useful for practicing an embodiment of the client 302 or a server 306. As shown in FIGS. 3C and 3D, each computing device 300 includes a central processing unit 321, and a main memory unit 322. As shown in FIG. 3C, a computing device 300 may include a storage device 328, an installation device 316, a network interface 318, an I/O controller 323, display devices 324a-324n, a keyboard 326 and a pointing device 327, e.g. a mouse. The storage device 328 may include, without limitation, an operating system, software, and a software of or associated with the system 100. As shown in FIG. 3D, each computing device 300 may also include additional optional elements, e.g. a memory port 303, a bridge 370, one or more input/output devices 330a-330n (generally referred to using reference numeral 330), and a cache memory 640 in communication with the central processing unit 321.

The central processing unit 321 is any logic circuitry that responds to and processes instructions fetched from the main memory unit 322. In many embodiments, the central processing unit 321 is provided by a microprocessor unit, e.g.: those manufactured by Intel Corporation of Mountain View, Calif.; those manufactured by Motorola Corporation of Schaumburg, Ill.; the ARM processor and TEGRA system on a chip (SoC) manufactured by Nvidia of Santa Clara, Calif.; the POWER7 processor, those manufactured by International Business Machines of White Plains, N.Y.; or those manufactured by Advanced Micro Devices of Sunnyvale, Calif. The computing device 300 may be based on any of these processors, or any other processor capable of operating as described herein. The central processing unit 321 may utilize instruction level parallelism, thread level parallelism, different levels of cache, and multi-core processors. A multi-core processor may include two or more processing units on a single computing component. Examples of a multi-core processors include the AMD PHENOM IIX2, INTEL CORE i5 and INTEL CORE i7.

Main memory unit 322 may include one or more memory chips capable of storing data and allowing any storage location to be directly accessed by the microprocessor 321. Main memory unit 322 may be volatile and faster than storage 328 memory. Main memory units 322 may be Dynamic random access memory (DRAM) or any variants, including static random access memory (SRAM), Burst SRAM or SynchBurst SRAM (BSRAM), Fast Page Mode DRAM (FPM DRAM), Enhanced DRAM (EDRAM), Extended Data Output RAM (EDO RAM), Extended Data Output DRAM (EDO DRAM), Burst Extended Data Output DRAM (BEDO DRAM), Single Data Rate Synchronous DRAM (SDR SDRAM), Double Data Rate SDRAM (DDR SDRAM), Direct Rambus DRAM (DRDRAM), or Extreme Data Rate DRAM (XDR DRAM). In some embodiments, the main memory 322 or the storage 328 may be non-volatile; e.g., non-volatile read access memory (NVRAM), flash memory non-volatile static RAM (nvSRAM), Ferroelectric RAM (FeRAM), Magnetoresistive RAM (MRAM), Phase-change memory (PRAM), conductive-bridging RAM (CBRAM), Silicon-Oxide-Nitride-Oxide-Silicon (SONOS), Resistive RAM (RRAM), Racetrack, Nano-RAM (NRAM), or Millipede memory.

The main memory 322 may be based on any of the above described memory chips, or any other available memory chips capable of operating as described herein. In the embodiment shown in FIG. 3C, the processor 321 communicates with main memory 322 via a system bus 350 (described in more detail below). FIG. 3D depicts an embodiment of a computing device 300 in which the processor communicates directly with main memory 322 via a memory port 303. For example, in FIG. 3D the main memory 322 may be DRDRAM.

FIG. 3D depicts an embodiment in which the main processor 321 communicates directly with cache memory 640 via a secondary bus, sometimes referred to as a backside bus. In other embodiments, the main processor 321 communicates with cache memory 640 using the system bus 350. Cache memory 640 typically has a faster response time than main memory 322 and is typically provided by SRAM, BSRAM, or EDRAM. In the embodiment shown in FIG. 3D, the processor 321 communicates with various I/O devices 330 via a local system bus 350. Various buses may be used to connect the central processing unit 321 to any of the I/O devices 330, including a PCI bus, a PCI-X bus, or a PCI-Express bus, or a NuBus. For embodiments in which the I/O device is a video display 324, the processor 321 may use an Advanced Graphics Port (AGP) to communicate with the display 324 or the I/O controller 323 for the display 324. FIG. 3D depicts an embodiment of a computer 300 in which the main processor 321 communicates directly with I/O device 330b or other processors 321′ via HYPERTRANSPORT, RAPIDIO, or INFINIBAND communications technology. FIG. 3D also depicts an embodiment in which local busses and direct communication are mixed: the processor 321 communicates with I/O device 330a using a local interconnect bus while communicating with I/O device 330b directly.

A wide variety of I/O devices 330a-330n may be present in the computing device 300. Input devices may include keyboards, mice, trackpads, trackballs, touchpads, touch mice, multi-touch touchpads and touch mice, microphones, multi-array microphones, drawing tablets, cameras, single-lens reflex camera (SLR), digital SLR (DSLR), CMOS sensors, accelerometers, infrared optical sensors, pressure sensors, magnetometer sensors, angular rate sensors, depth sensors, proximity sensors, ambient light sensors, gyroscopic sensors, or other sensors. Output devices may include video displays, graphical displays, speakers, headphones, inkjet printers, laser printers, and 3D printers.

Devices 330a-330n may include a combination of multiple input or output devices, including, e.g., Microsoft KINECT, Nintendo Wiimote for the WIT, Nintendo WII U GAMEPAD, or Apple IPHONE. Some devices 330a-330n allow gesture recognition inputs through combining some of the inputs and outputs. Some devices 330a-330n provides for facial recognition which may be utilized as an input for different purposes including authentication and other commands. Some devices 330a-330n provides for voice recognition and inputs, including, e.g., Microsoft KINECT, SIRI for IPHONE by Apple, Google Now or Google Voice Search.

Additional devices 330a-330n have both input and output capabilities, including, e.g., haptic feedback devices, touchscreen displays, or multi-touch displays. Touchscreen, multi-touch displays, touchpads, touch mice, or other touch sensing devices may use different technologies to sense touch, including, e.g., capacitive, surface capacitive, projected capacitive touch (PCT), in-cell capacitive, resistive, infrared, waveguide, dispersive signal touch (DST), in-cell optical, surface acoustic wave (SAW), bending wave touch (BWT), or force-based sensing technologies. Some multi-touch devices may allow two or more contact points with the surface, allowing advanced functionality including, e.g., pinch, spread, rotate, scroll, or other gestures. Some touchscreen devices, including, e.g., Microsoft PIXELSENSE or Multi-Touch Collaboration Wall, may have larger surfaces, such as on a table-top or on a wall, and may also interact with other electronic devices. Some I/O devices 330a-330n, display devices 324a-324n or group of devices may be augment reality devices. The I/O devices may be controlled by an I/O controller 323 as shown in FIG. 3C. The I/O controller may control one or more I/O devices, such as, e.g., a keyboard 326 and a pointing device 327, e.g., a mouse or optical pen. Furthermore, an I/O device may also provide storage and/or an installation medium 316 for the computing device 300. In still other embodiments, the computing device 300 may provide USB connections (not shown) to receive handheld USB storage devices. In further embodiments, an I/O device 330 may be a bridge between the system bus 350 and an external communication bus, e.g. a USB bus, a SCSI bus, a FireWire bus, an Ethernet bus, a Gigabit Ethernet bus, a Fibre Channel bus, or a Thunderbolt bus.

In some embodiments, display devices 324a-324n may be connected to I/O controller 323. Display devices may include, e.g., liquid crystal displays (LCD), thin film transistor LCD (TFT-LCD), blue phase LCD, electronic papers (e-ink) displays, flexile displays, light emitting diode displays (LED), digital light processing (DLP) displays, liquid crystal on silicon (LCOS) displays, organic light-emitting diode (OLED) displays, active-matrix organic light-emitting diode (AMOLED) displays, liquid crystal laser displays, time-multiplexed optical shutter (TMOS) displays, or 3D displays. Examples of 3D displays may use, e.g. stereoscopy, polarization filters, active shutters, or autostereoscopy. Display devices 324a-324n may also be a head-mounted display (HMD). In some embodiments, display devices 324a-324n or the corresponding I/O controllers 323 may be controlled through or have hardware support for OPENGL or DIRECTX API or other graphics libraries.

In some embodiments, the computing device 300 may include or connect to multiple display devices 324a-324n, which each may be of the same or different type and/or form. As such, any of the I/O devices 330a-330n and/or the I/O controller 323 may include any type and/or form of suitable hardware, software, or combination of hardware and software to support, enable or provide for the connection and use of multiple display devices 324a-324n by the computing device 300. For example, the computing device 300 may include any type and/or form of video adapter, video card, driver, and/or library to interface, communicate, connect or otherwise use the display devices 324a-324n. In one embodiment, a video adapter may include multiple connectors to interface to multiple display devices 324a-324n. In other embodiments, the computing device 300 may include multiple video adapters, with each video adapter connected to one or more of the display devices 324a-324n. In some embodiments, any portion of the operating system of the computing device 300 may be configured for using multiple displays 324a-324n. In other embodiments, one or more of the display devices 324a-324n may be provided by one or more other computing devices 300a or 300b connected to the computing device 300, via the network 304. In some embodiments software may be designed and constructed to use another computer's display device as a second display device 324a for the computing device 300. For example, in one embodiment, an Apple iPad may connect to a computing device 300 and use the display of the device 300 as an additional display screen that may be used as an extended desktop. One ordinarily skilled in the art will recognize and appreciate the various ways and embodiments that a computing device 300 may be configured to have multiple display devices 324a-324n.

Referring again to FIG. 3C, the computing device 300 may comprise a storage device 328 (e.g. one or more hard disk drives or redundant arrays of independent disks) for storing an operating system or other related software, and for storing application software programs such as any program related to the software 320 for the experiment tracker system. Examples of storage device 328 include, e.g., hard disk drive (HDD); optical drive including CD drive, DVD drive, or BLU-RAY drive; solid-state drive (SSD); USB flash drive; or any other device suitable for storing data. Some storage devices may include multiple volatile and non-volatile memories, including, e.g., solid state hybrid drives that combine hard disks with solid state cache. Some storage device 328 may be non-volatile, mutable, or read-only. Some storage device 328 may be internal and connect to the computing device 300 via a bus 350. Some storage device 328 may be external and connect to the computing device 300 via a I/O device 330 that provides an external bus. Some storage device 328 may connect to the computing device 300 via the network interface 318 over a network 304, including, e.g., the Remote Disk for MACBOOK AIR by Apple. Some client devices 302 may not require a non-volatile storage device 328 and may be thin clients or zero clients 302. Some storage device 328 may also be used as a installation device 316, and may be suitable for installing software and programs. Additionally, the operating system and the software can be run from a bootable medium, for example, a bootable CD, e.g. KNOPPIX, a bootable CD for GNU/Linux that is available as a GNU/Linux distribution from knoppix.net.

Client device 302 may also install software or application from an application distribution platform. Examples of application distribution platforms include the App Store for iOS provided by Apple, Inc., the Mac App Store provided by Apple, Inc., GOOGLE PLAY for Android OS provided by Google Inc., Chrome Webstore for CHROME OS provided by Google Inc., and Amazon Appstore for Android OS and KINDLE FIRE provided by Amazon.com, Inc. An application distribution platform may facilitate installation of software on a client device 302. An application distribution platform may include a repository of applications on a server 306 or a cloud 308, which the clients 302a-302n may access over a network 304. An application distribution platform may include application developed and provided by various developers. A user of a client device 302 may select, purchase and/or download an application via the application distribution platform.

Furthermore, the computing device 300 may include a network interface 318 to interface to the network 304 through a variety of connections including, but not limited to, standard telephone lines LAN or WAN links (e.g., 802.11, T1, T3, Gigabit Ethernet, Infiniband), broadband connections (e.g., ISDN, Frame Relay, ATM, Gigabit Ethernet, Ethernet-over-SONET, ADSL, VDSL, BPON, GPON, fiber optical including FiOS), wireless connections, or some combination of any or all of the above. Connections can be established using a variety of communication protocols (e.g., TCP/IP, Ethernet, ARCNET, SONET, SDH, Fiber Distributed Data Interface (FDDI), IEEE 802.11a/b/g/n/ac CDMA, GSM, WiMax and direct asynchronous connections). In one embodiment, the computing device 300 communicates with other computing devices 300′ via any type and/or form of gateway or tunneling protocol e.g. Secure Socket Layer (SSL) or Transport Layer Security (TLS), or the Citrix Gateway Protocol manufactured by Citrix Systems, Inc. of Ft. Lauderdale, Fla. The network interface 318 may comprise a built-in network adapter, network interface card, PCMCIA network card, EXPRESSCARD network card, card bus network adapter, wireless network adapter, USB network adapter, modem or any other device suitable for interfacing the computing device 300 to any type of network capable of communication and performing the operations described herein.

A computing device 300 of the sort depicted in FIGS. 3B and 3C may operate under the control of an operating system, which controls scheduling of tasks and access to system resources. The computing device 300 can be running any operating system such as any of the versions of the MICROSOFT WINDOWS operating systems, the different releases of the Unix and Linux operating systems, any version of the MAC OS for Macintosh computers, any embedded operating system, any real-time operating system, any open source operating system, any proprietary operating system, any operating systems for mobile computing devices, or any other operating system capable of running on the computing device and performing the operations described herein. Typical operating systems include, but are not limited to: WINDOWS 2000, WINDOWS Server 2012, WINDOWS CE, WINDOWS Phone, WINDOWS XP, WINDOWS VISTA, and WINDOWS 7, WINDOWS RT, and WINDOWS 8 all of which are manufactured by Microsoft Corporation of Redmond, Wash.; MAC OS and iOS, manufactured by Apple, Inc. of Cupertino, Calif.; and Linux, a freely-available operating system, e.g. Linux Mint distribution (“distro”) or Ubuntu, distributed by Canonical Ltd. of London, United Kingom; or Unix or other Unix-like derivative operating systems; and Android, designed by Google, of Mountain View, Calif., among others. Some operating systems, including, e.g., the CHROME OS by Google, may be used on zero clients or thin clients, including, e.g., CHROMEBOOKS.

The computer system 300 can be any workstation, telephone, desktop computer, laptop or notebook computer, netbook, ULTRABOOK, tablet, server, handheld computer, mobile telephone, smartphone or other portable telecommunications device, media playing device, a gaming system, mobile computing device, or any other type and/or form of computing, telecommunications or media device that is capable of communication. The computer system 300 has sufficient processor power and memory capacity to perform the operations described herein. In some embodiments, the computing device 300 may have different processors, operating systems, and input devices consistent with the device. The Samsung GALAXY smartphones, e.g., operate under the control of Android operating system developed by Google, Inc. GALAXY smartphones receive input via a touch interface.

In some embodiments, the computing device 300 is a gaming system. For example, the computer system 300 may comprise a PLAYSTATION 3, or PERSONAL PLAYSTATION PORTABLE (PSP), or a PLAYSTATION VITA device manufactured by the Sony Corporation of Tokyo, Japan, a NINTENDO DS, NINTENDO 3DS, NINTENDO WII, or a NINTENDO WII U device manufactured by Nintendo Co., Ltd., of Kyoto, Japan, an XBOX 360 device manufactured by the Microsoft Corporation of Redmond, Wash.

In some embodiments, the computing device 300 is a digital audio player such as the Apple IPOD, IPOD Touch, and IPOD NANO lines of devices, manufactured by Apple Computer of Cupertino, Calif. Some digital audio players may have other functionality, including, e.g., a gaming system or any functionality made available by an application from a digital application distribution platform. For example, the IPOD Touch may access the Apple App Store. In some embodiments, the computing device 300 is a portable media player or digital audio player supporting file formats including, but not limited to, MP3, WAV, M4A/AAC, WMA Protected AAC, AIFF, Audible audiobook, Apple Lossless audio file formats and .mov, .m4v, and .mp4 MPEG-4 (H.264/MPEG-4 AVC) video file formats.

In some embodiments, the computing device 300 is a tablet e.g. the IPAD line of devices by Apple; GALAXY TAB family of devices by Samsung; or KINDLE FIRE, by Amazon.com, Inc. of Seattle, Wash. In other embodiments, the computing device 300 is a eBook reader, e.g. the KINDLE family of devices by Amazon.com, or NOOK family of devices by Barnes & Noble, Inc. of New York City, N.Y.

In some embodiments, the communications device 302 includes a combination of devices, e.g. a smartphone combined with a digital audio player or portable media player. For example, one of these embodiments is a smartphone, e.g. the IPHONE family of smartphones manufactured by Apple, Inc.; a Samsung GALAXY family of smartphones manufactured by Samsung, Inc; or a Motorola DROID family of smartphones. In yet another embodiment, the communications device 302 is a laptop or desktop computer equipped with a web browser and a microphone and speaker system, e.g. a telephony headset. In these embodiments, the communications devices 302 are web-enabled and can receive and initiate phone calls. In some embodiments, a laptop or desktop computer is also equipped with a webcam or other video capture device that enables video chat and video call.

In some embodiments, the status of one or more machines 302, 306 in the network 304 can be monitored as part of network management. In one of these embodiments, the status of a machine may include an identification of load information (e.g., the number of processes on the machine, CPU and memory utilization), of port information (e.g., the number of available communication ports and the port addresses), or of session status (e.g., the duration and type of processes, and whether a process is active or idle). In another of these embodiments, this information may be identified by a plurality of metrics, and the plurality of metrics can be applied at least in part towards decisions in load distribution, network traffic management, and network failure recovery as well as any aspects of operations of the present solution described herein. Aspects of the operating environments and components described above will become apparent in the context of the systems and methods disclosed herein.

Embodiments of the subject matter and the operations described in this specification can be implemented in digital electronic circuitry, or in computer software, firmware, or hardware, including the structures disclosed in this specification and their structural equivalents, or in combinations of one or more of them. The subject matter described in this specification can be implemented as one or more computer programs, e.g., one or more circuits of computer program instructions, encoded on one or more computer storage media for execution by, or to control the operation of, data processing apparatus. Alternatively or in addition, the program instructions can be encoded on an artificially generated propagated signal, e.g., a machine-generated electrical, optical, or electromagnetic signal that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially generated propagated signal. The computer storage medium can also be, or be included in, one or more separate components or media (e.g., multiple CDs, disks, or other storage devices).

It should be understood that the systems described above may provide multiple ones of any or each of those components and these components may be provided on either a standalone machine or, in some embodiments, on multiple machines in a distributed system. The systems and methods described above may be implemented as a method, apparatus or article of manufacture using programming and/or engineering techniques to produce software, firmware, hardware, or any combination thereof. In addition, the systems and methods described above may be provided as one or more computer-readable programs embodied on or in one or more articles of manufacture. The term “article of manufacture” as used herein is intended to encompass code or logic accessible from and embedded in one or more computer-readable devices, firmware, programmable logic, memory devices (e.g., EEPROMs, ROMs, PROMs, RAMs, SRAMs, etc.), hardware (e.g., integrated circuit chip, Field Programmable Gate Array (FPGA), Application Specific Integrated Circuit (ASIC), etc.), electronic devices, a computer readable non-volatile storage unit (e.g., CD-ROM, floppy disk, hard disk drive, etc.). The article of manufacture may be accessible from a file server providing access to the computer-readable programs via a network transmission line, wireless transmission media, signals propagating through space, radio waves, infrared signals, etc. The article of manufacture may be a flash memory card or a magnetic tape. The article of manufacture includes hardware logic as well as software or programmable code embedded in a computer readable medium that is executed by a processor. The computer-readable programs can be implemented in a programming language, such as LISP, PERL, C, C++, C#, PROLOG, or in any byte code language such as JAVA. The software programs may be stored on or in one or more articles of manufacture as object code.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can be integrated in a single software product or packaged into multiple software products.

References to “or” may be construed as inclusive so that any terms described using “or” may indicate any of a single, more than one, and all of the described terms.

Thus, particular embodiments of the subject matter have been described. Other embodiments are within the scope of the following claims. In some cases, the actions recited in the claims can be performed in a different order and still achieve desirable results. In addition, the processes depicted in the accompanying figures may be performed in any order. In certain embodiments, multitasking and parallel processing may be advantageous.

While this specification contains many specific implementation details, these should not be construed as limitations on the scope of any subject matter of what may be claimed, but rather as descriptions of features specific to particular implementations of the subject matter. Certain features described in this specification in the context of separate embodiments can also be implemented in combination in a single embodiment. Conversely, various features described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

What is claim is:

1. A method of detecting fraudulent transactions, comprising:
detecting, by a control system comprising a processor and memory, an online transaction initiated by a computing device;
determining, by the control system responsive to identifying that the online transaction is in a first state, a first value corresponding to information of the computing device;
obtaining, by the control system responsive to identifying that the online transaction is in the first state, a first look-up value corresponding to the first value;
selecting, by the control system, a first routing policy based on comparing the first value with the first look-up value;
determining, by the control system responsive to identifying that the online transaction is in a second state, a second value from a field of the online transaction;
obtaining, by the control system responsive to identifying that the online transaction is in the second state, a corresponding second look-up value corresponding to the second value;
selecting, by the control system, a second routing policy based on comparing the second value with the second look-up value;
determining, by the control system, to interrupt the online transaction based on detecting a presence of a match between at least one of the first value and the first look-up value or the second value and the second look-up value; and
interrupting, by the control system responsive to the determination, the online transaction to direct the online transaction to a resolving state according to either the first routing policy or the second routing policy.

2. The method of claim 1, further comprising:
intercepting, by the control system, network traffic originated from the computing device to identify the first value corresponding to the information of the computing device.

3. The method of claim 1, wherein the information of the computing device comprises an IP address of the computing device that initiated the online transaction.

4. The method of claim 1, further comprising:
determining, by the control system, a geographic location of the computing device as the first value according to the information of the computing device;
obtaining, by the control system, a list of flagged geographic locations as the first look-up value;
determining the presence of the match between the first value and the first look-up value by identifying that the geographic location of the computing device is located in one of the flagged geographic locations; and
directing, by the control system according to the first routing policy, the online transaction to the resolving state including at least one of blocking the online transaction or initiating at least one further authentication process to be performed through the computing device.

5. The method of claim 1 further comprising:
determining, by the control system according to the information of the computing device, a connection type through which the computing device initiated the online transaction as the first value;
obtaining, by the control system, a list of flagged connection types as of the first look-up value;
determining the presence of the match between the first value and the first look-up value by identifying that the connection type is among the list of flagged connection types; and
directing, by the control system according to the first routing policy, the online transaction to the resolving state including at least one of blocking the online transaction or initiating at least one further authentication process to be performed through the computing device.

6. The method of claim 1, wherein the field of the online transaction comprises at least one of: a first name field, a last name field, an organization name field, a domain name field, and a phone number field.

7. The method of claim 1, further comprising:
obtaining, by the control system, responsive to identifying the second value corresponding to a value for at least one of a first name field or a last name field, a list of flagged first names or last names as the second look-up value;
determining the presence of the match between the second value and the second look-up value by identifying that the second value is one of the flagged first names or last names; and
directing, by the control system according to the second routing policy, the online transaction to the resolving state including at least one of blocking the online transaction or initiating at least one further authentication process to be performed through the computing device.

8. The method of claim 1, further comprising:
obtaining, by the control system, responsive to identifying the second value corresponding to a value for an organization name field, a list of flagged first names or last names as the second look-up value;
determining the presence of the match between the second value and the second look-up value by identifying that the second value is one of the flagged first names or last names; and
directing, by the control system according to the second routing policy, the online transaction to the resolving state including at least one of blocking the online transaction or initiating at least one further authentication process to be performed through the computing device.

9. The method of claim 1, further comprising:
obtaining, by the control system, responsive to identifying the second value corresponding to a value for a phone number field, a list of flagged phone number digits as the second look-up value;
determining the presence of the match between the second value and the second look-up value by identifying that a number of digits of the second value matches one of the flagged phone number digits; and
directing, by the control system according to the second routing policy, the online transaction to the resolving state including at least one of blocking the online transaction or initiating at least one further authentication process to be performed through the computing device.

10. The method of claim 1, further comprising:
according to the first routing policy, allowing, by the control system responsive to detecting an absence of the match between the first value and the first look-up value, the online transaction to proceed to the second state; and
according to the second routing policy, directing, by the control system responsive to detecting the presence of the match between the second value and the second look-up value, the online transaction to the resolving state including at least one of blocking the online transaction or initiating at least one further authentication process to be performed through the computing device.

11. A system to detect fraudulent purchases, comprising:
a control system comprising one or more processors and memory, the control system configured to:
detect an online transaction initiated by a computing device;
determine, responsive to identifying that the online transaction is in a first state, a first value corresponding to information of the computing device;
obtain, responsive to identifying that the online transaction is in the first state, a first look-up value corresponding to the first value;
select a first routing policy based on comparing the first value with the first look-up value;
determine, responsive to identifying that the online transaction is in a second state, a second value from a field of the online transaction;
obtain, responsive to identifying that the online transaction is in the second state, a corresponding second look-up value corresponding to the second value;
select a second routing policy based on comparing the second value with the second look-up value;
determine to interrupt the online transaction based on detecting a presence of a match between at least one of the first value and the first look-up value or the second value and the second look-up value; and
interrupt, responsive to the determination, the online transaction to direct the online transaction to a resolving state according to either the first routing policy or the second routing policy.

12. The system of claim 11, wherein the control system is further configured to:
intercept network traffic originated from the computing device to identify the first value corresponding to the information of the computing device.

13. The system of claim 11, wherein the information of the computing device comprises an IP address of the computing device that initiated the online transaction.

14. The system of claim 11, wherein the control system is further configured to:
determine a geographic location of the computing device as the first value according to the information of the computing device;
obtain a list of flagged geographic locations as the first look-up value;
determine the presence of the match between the first value and the first look-up value by identifying that the geographic location of the computing device is located in one of the flagged geographic locations; and
direct, according to the first routing policy, the online transaction to the resolving state including at least one of blocking the online transaction or initiating at least one further authentication process to be performed through the computing device.

15. The system of claim 11, wherein the control system is further configured to:
determine, according to the information of the computing device, a connection type through which the computing device initiated the online transaction as the first value;
obtain a list of flagged connection types as of the first look-up value;
determine the presence of the match between the first value and the first look-up value by identifying that the connection type is among the list of flagged connection types; and
direct, according to the first routing policy, the online transaction to the resolving state including at least one of blocking the online transaction or initiating at least one further authentication process to be performed through the computing device.

16. The system of claim 11, wherein the field of the online transaction comprises at least one of: a first name field, a last name field, an organization name field, a domain name field, and a phone number field.

17. The system of claim 11, wherein the control system is further configured to:
obtain, responsive to identifying the second value corresponding to a value for at least one of a first name field or a last name field, a list of flagged first names or last names as the second look-up value;
determine the presence of the match between the second value and the second look-up value by identifying that the second value is one of the flagged first names or last names; and
direct, according to the second routing policy, the online transaction to the resolving state including at least one of blocking the online transaction or initiating at least one further authentication process to be performed through the computing device.

18. The system of claim 11, wherein the control system is further configured to:
obtain, responsive to identifying the second value corresponding to a value for an organization name field, a list of flagged first names or last names as the second look-up value;
determine the presence of the match between the second value and the second look-up value by identifying that the second value is one of the flagged first names or last names; and
direct, according to the second routing policy, the online transaction to the resolving state including at least one of blocking the online transaction or initiating at least one further authentication process to be performed through the computing device.

19. The system of claim 11, wherein the control system is further configured to:
obtain, responsive to identifying the second value corresponding to a value for a phone number field, a list of flagged phone number digits as the second look-up value;
determine the presence of the match between the second value and the second look-up value by identifying that a number of digits of the second value matches one of the flagged phone number digits; and
direct, according to the second routing policy, the online transaction to the resolving state including at least one of blocking the online transaction or initiating at least one further authentication process to be performed through the computing device.

20. The system of claim 11, wherein the control system is further configured to:
allow, responsive to detecting an absence of the match between the first value and the first look-up value, the online transaction to proceed to the second state according to the first routing policy; and
direct, by the control system responsive to detecting the presence of the match between the second value and the second look-up value, the online transaction to the resolving state according to the second routing policy, the resolving state including at least one of blocking the online transaction or initiating at least one further authentication process to be performed through the computing device.
